(19) United States
(12) Patent Application Publication
(10) Pub. No.: US 2015/0062814 A1
(43) Pub. Date: Mar. 5, 2015

(54) IMAGE FORMING APPARATUS

(71) Applicant: KYOCERA Document Solutions Inc., Osaka (JP)

(72) Inventor: Yoshifumi OKAUCHI, Osaka (JP)

(73) Assignee: KYOCERA DOCUMENT SOLUTIONS INC., Osaka (JP)

(21) Appl. No.: 14/465,191

(22) Filed: Aug. 21, 2014

(30) Foreign Application Priority Data
Aug. 27, 2013 (JP) 2013-175109

(51) Int. Cl. H04N 1/00

(52) U.S. Cl. CPC H04N 1/00989; H04N 1/00557; H04N 1/0083
USPC 361/694

(57) ABSTRACT

An image forming apparatus includes a main body, an upper-portion device, a substrate, an electronic wire, and a duct. The main body has an upper surface and an insertion hole formed in the upper surface. The upper-portion device is disposed above the main body. The substrate is disposed inside the main body. The electronic wire is inserted into the insertion hole to connect the substrate and the upper-portion device. The duct has an interior space extending from the insertion hole and guides the electronic wire from a rear side of the main body and the upper-portion device into insertion hole.

### INCORPORATION BY REFERENCE

The present application claims priority under 35 U.S.C. §119 to Japanese Patent Application No. 2013-175109, filed Aug. 27, 2013. The contents of this application are incorporated herein by reference in their entirety.

### BACKGROUND

The present disclosure relates to image forming apparatuses. Some image forming apparatuses include a main body and a reading device disposed above the main body. In such an image forming apparatus, the reading device is connected by an electrical wire to an electronic substrate provided inside the main body.

### SUMMARY

An image forming apparatus according to the present disclosure includes a main body, an upper-portion device, a substrate, an electronic wire, and a duct. The main body has an upper surface and an insertion hole formed in the upper surface. The upper-portion device is disposed above the main body. The substrate is disposed inside the main body. The electronic wire is inserted into the insertion hole to connect the substrate and the upper-portion device. The duct has an interior space extending from the insertion hole and guides the electronic wire from a rear side of the main body and the upper-portion device into the insertion hole.

### BRIEF DESCRIPTION OF THE DRAWINGS

FIG. 1 is a cross-sectional view of an image forming apparatus according to an embodiment.

FIG. 2 is a rear view of the image forming apparatus according to the embodiment.

### DETAILED DESCRIPTION

The following describes an embodiment of the present disclosure in detail with reference to the accompanying drawings. However, the present disclosure is not limited to the specific embodiment described below.

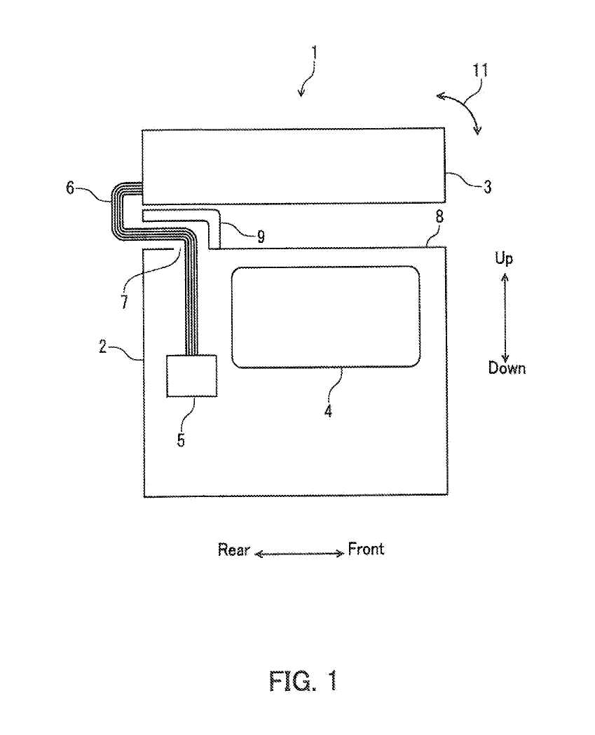

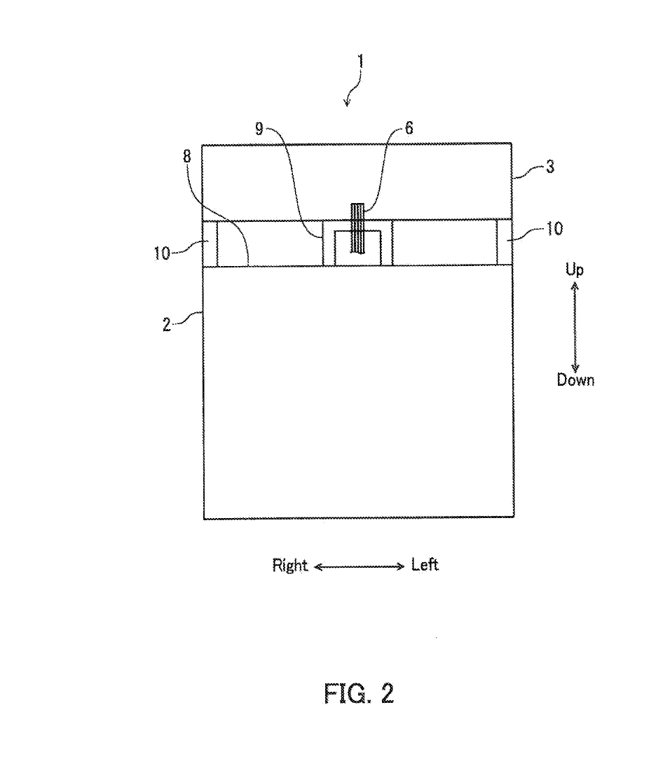

FIG. 1 is a cross-sectional view of an image forming apparatus 1 according to the present embodiment. FIG. 2 is a rear view of the image forming apparatus 1 according to the present embodiment. The image forming apparatus 1 according to the present embodiment is a multifunction peripheral, for example. As shown in FIGS. 1 and 2, the image forming apparatus 1 includes a main body 2 and a reading device 3. The reading device 3 is one example of an upper-portion device that is disposed above the main body 2. The upper-portion device is not limited to the reading device 3 and may be a document feeding unit, such as a document feeing device disclosed in Japanese Patent Application Laid-Open Publication No. 2000-131907, for example.

The main body 2 includes an image forming section 4 and a fixing section (not shown). The image forming section 4 and the fixing section (not shown) are accommodated in the main body 2. The image forming section 4 forms an image on paper. The main body 2 further includes an electronic substrate 5 also accommodated in the main body 2. The electronic substrate 5 controls the image forming section 4 and the reading device 3. Although not shown in the figures, the image forming apparatus 1 includes a paper feed section and a paper discharge section disposed on the main body 2. The paper feed section feeds paper to the image forming section 4. The image forming section 4 forms an image on the paper. The paper having been subjected to the image forming by the image forming section 4 and the fixing by the fixing section is discharged to the paper discharge section. The reading device 3 reads an original document, or the like.

In addition, the image forming apparatus 1 includes two supporting members 10 (see FIG. 2). The two supporting members 10 are disposed on an upper surface 8 of the main body 2. The two support members 10 are each disposed at either of the right and left edges of the main body 2 and at a position toward a rear side of the main body 2. The reading device 3 is mounted on the two support members 10 to be pivotable about the two support members 10 as the pivot (as indicated by an arrow 11 shown in FIG. 1).

The reading device 3 and the electronic substrate 5 are connected by an electrical wire 6. Through the electrical wire 6, a driving power and a control signal are transferred between the reading device 3 and the electronic substrate 5. The upper surface 8 of the main body 2 has an insertion hole 7 for insertion of the electrical wire 6 at a position on the main body 2 toward the rear side. The electrical wire 6 is connected at one end to the rear surface of the reading device 3. The electrical wire 6 extending from the reading device 3 is passed between the reading device 3 and the main body 2 to reach the insertion hole 7. The electrical wire 6 inserted into the insertion hole 7 is connected at the other end to the electronic substrate 5 disposed inside the main body 2. That is, the electrical wire 6 extending from the rear surface of the reading device 3 is received in the space between the reading device 3 and the main body 2 and then inserted into the main body 2 through the upper surface 8 of the main body 2.

The image forming apparatus 1 further includes a duct 9. The duct 9 is disposed between the main body 2 and the reading device 3. The duct 9 guides the electrical wire 6 from the rear side of the main body 2 and the reading device 3 (that is, the rear side of the image forming apparatus 1) into the insertion hole 7. In the main body 2, hot air is generated by heat of the image forming section 4, the electronic substrate 5, the fixing section, and the like. The cover, which for example is the duct 9, is configured to release the hot air generated in the main body 2 toward the rear side of the main body 2 and the reading device 3.

According to the present embodiment, the insertion hole 7 for insertion of the electrical wire 6 is formed in the upper surface 8 of the main body 2. The electrical wire 6 extends from the reading device 3, passes between the reading device 3 and the main body 2, and enters the insertion hole 7 to be connected to the electronic substrate 5. Consequently, the electrical wire 6 can be arranged with a minimum portion exposed to the outside. This arrangement is effective to eliminate or reduce the risk that the electrical wire 6 is accidently pulled by a user to break the electrical wire 6. In addition, degradation in the appearance of the image forming apparatus 1 can be avoided.

According to the structure of the present embodiment, in addition, the duct 9 is disposed between the main body 2 and the reading device 3. The duct 9 guides the electrical wire 6 from the rear side of the main body 2 and the reading device 3 (that is, the rear side of the image forming apparatus 1) into the insertion hole 7. Therefore, the duct 9 may be arranged to cover the insertion hole 7 from above. This arrangement is effective to prevent or reduce the entry of foreign matter, such as dust, into the main body 2 through the insertion hole 7. Thus, the present embodiment can eliminate or reduce the risk that foreign matter enters from the insertion hole 7 that is for the electrical wire 6. In addition, the electrical wire 6 can be arranged with a minimum portion exposed to the outside.

According to the structure of the present embodiment, in addition, the insertion hole 7 is formed in the upper surface 8 of the main body 2. Since hot air generally tends to rise, the above-described structure can effectively allow the hot air generated inside the main body 2 to escape from the insertion hole 7.

In addition, the hot air escaped from the insertion hole 7 can be guided through the duct 9 to be released toward the rear side of the main body 2 and the reading device 3 (that is, the rear side of the image forming apparatus 1). Specifically speaking, the duct 9 has a squared U shape in cross section as shown in FIG. 2. In cross section, the interior space of the duct 9 is bounded by the wall surfaces of the duct 9 on three sides, namely the upper side, left side, and the right side. In addition, the duct 9 has an opening facing the rear side of the main body 2 and the reading device 3. This structure can reliably allow for the escape of the hot air toward the rear side of the image forming apparatus 1. In other words, the present embodiment can effectively release the hot air inside the main body 2 to the outside of the image forming apparatus 1 from the rear portion of the image forming apparatus 1 through the insertion hole 7, which is for insertion of the electrical wire 6, and the duct 9. This can eliminate or reduce the risk that the user feels uncomfortable due to the hot air.

According to the present embodiment, in addition, the duct 9 is disposed in the widthwise center (the center in the right-and-left direction) of the main body 2 and the reading device 3 (see FIG. 2). This can ensure that the electrical wire 6 to be disposed at the farthest possible position from the user. This arrangement is effective to reduce the risk that the electrical wire 6 is accidently pulled by the user. In addition, appearance degradation of the image forming apparatus 1 is further avoided.

According to present embodiment, in addition, the reading device 3 is supported on the two support members 10, and the pivot axis of the reading device 3 lies on a position toward the rear side of the image forming apparatus 1. The duct 9 is disposed between the two support members 10. That is, the duct 9 is disposed adjacent to the pivot axis. This permits easy insertion of the electrical wire 6 into the duct 9.

The description of the present embodiment is directed to a multifunction peripheral as an example of the image forming apparatus 1. However, the image forming apparatus 1 is not limited to such and may be any other image forming apparatus, such as a printer, a reading device, a copier, or the like.

What is claimed is:

1. An image forming apparatus comprising:
a main body having an upper surface and an insertion hole formed in the upper surface;
an upper-portion device disposed above the main body;
a substrate disposed inside the main body;
an electronic wire inserted into the insertion hole to connect the substrate and the upper-portion device; and
a duct that has an interior space extending from the insertion hole and is configured to guide the electronic wire from a rear side of the main body and the upper-portion device into the insertion hole.

2. An image forming apparatus according to claim 1, wherein
the duct is configured to release hot air inside the main body toward the rear side.

3. An image forming apparatus according to claim 1, wherein
the duct has a squared U shape in cross section and having an opening facing the rear side.

4. An image forming apparatus according to claim 3, wherein
the interior space of the duct is bounded, in cross section, by wall surfaces of the duct on three sides that are an upper side, a left side, and a right side.

5. An image forming apparatus according to claim 1, wherein
the duct is located in a widthwise center of the main body and the upper-portion device.

6. An image forming apparatus according to claim 1, wherein
the upper-portion device is a reading device or a document feeding device.

7. An image forming apparatus according to claim 1, wherein
the main body further includes a support member at a position toward the rear side and configured to support the upper-portion device, wherein
the duct is adjacent to the support member.
